(19) United States
(12) Patent Application Publication
(10) Pub. No.: US 2008/0168341 A1
(43) Pub. Date: Jul. 10, 2008

(54) Digital spreadsheet formula automation

(76) Inventor: Raymond Payette, Quebec (CA)

Correspondence Address: RAYMOND PAYETTE, 3475 VAUTELET # 306, QUEBEC, QC, GIW 4V9, omitted

(21) Appl. No.: 11/651,395

(22) Filed: Jan. 10, 2007

(51) Int. Cl. G06F 17/00

(52) U.S. Cl. 715/212; 715/267

(57) ABSTRACT

A digital spreadsheet system that recognizes formula names and formula variables in real-time, that constructs a formula in accord with the formula's name and that enters it in the associated cell. The digital spreadsheet method consists of recognizing a formula's name, of traversing the spreadsheet's used range to identify the formula related variables, of identifying errors and missing information, and if applicable of prompting the author to correct the errors and to complete the missing variables, of constructing a formula that relates to the formula's name, of recognizing the likely place the result is to be inserted, of asserting that no other data is located at that place, and if applicable of prompting the author to specify an alternate location and of inserting the completed formula at that location.

### TECHNICAL FIELD

The present invention relates to digital spreadsheets.

### BACKGROUND OF THE INVENTION

Digital spreadsheets are widely used application programs that memorize, format and display data, that do many kinds of calculations including mathematical, statistical, financial and trigonometric functions and formulas, plus many kinds of analysis, including graphs, drawings, database and internet queries.

Microsoft Corporation makes the digital spreadsheet named Excel® that is recognized as being the current standard in digital spreadsheets and it is used in the present description. A workbook may contain many spreadsheets. Many workbooks may be linked. Other objects, such as Internet data may also be liked to a worksheet. A spreadsheet displays rows and columns of cells where data, formulas and objects such as graphs are inserted. Each cell can be referred to in an absolute way such as B3 that represents the cell located in the second column and the third row.

Excel® has a multitude of functionalities such as toolbars, a formula bar and, a spell checker that traverses a worksheet's text, parses words and compares it to various digital dictionaries to seek errors and to propose alternate spelling or grammatical corrections. Excel® also uses Data Analysis that produces some interfaces that require the author to specify where the variables are to be located to produce set results such as Descriptive Statistics. Excel® has a function that, in accordance with U.S. Pat. No. 6,055,548, calculates intermediate results of a preset function. Most mathematical functions have been embedded in the digital spreadsheet program and are easily entered with the use of the formula bar.

Presently spreadsheet authors enter data in a column that can be entitled Monthly_Sales; the rows may be identified with a name such as March; at the bottom of the column the author enters a formula name such as Total and he enters a formula either by clicking on the sum icon, Σ, by clicking the formula bar icon, fₓ, or by writing the formula preceded with a “=”, such as “=SUM(C2:C12)”. His task may be eased with mechanisms such as tooltips, “smart tags” and help interfaces. Presently it is at least a two-step method that involves entering the formula itself and the formula's name. Excel® recognizes labels in a “natural language” and a reference of Monthly_Sales March will be the variable located at the intersection of the Monthly_Sales column and the March row; but it does not provide any meaning to titles by any analogy or association. Presently Excel® does not recognize formula names and their associated variables unless they are already included in a formula, so the author must specify their location in an interface, such as dialog box, a pull-down menu, or directly in a formula. It would be useful that a spreadsheet automatically recognize variables in association with the formula names. This would avoid the use of interfaces and it would accelerate the calculation of results. Recognition of the variables and of the expected formula would automate the process of calculation and this would be a significant improvement to spreadsheets. For example if an author enters the formula name Grand Total, the spreadsheet system would infer that the corresponding cells should contain the sum of all Totals above it and it would build the appropriate formulas and it would enter them in the corresponding cells, thus speeding up the process and avoiding errors.

Digital spreadsheets are complex and it is understandable their manufacturers have put a great deal of effort in facilitating their use and to make them accessible to as many people as possible. They have included tips, pop-up information, wizards, auto-complete functionalities and the like. On one hand this reduces the need for the author to memorize formula names, their arguments and their syntax. To experts however these aids impede their work and tend to disrupt their thought process. Experts who frequently use formulas would benefit from specifying all the variables and their names as well as the formula's name that would immediately insert the proper formula and display its result.

### SUMMARY OF THE INVENTION

It is an object of this invention to provide a system for automating digital spreadsheet formulas by recognizing in real-time and without the author's intervention formulas identified with their names by assembling their variables also identified with their names and to identify errors and missing variables pertaining to identified formulas and if everything is acceptable to enter the completed formula in the most appropriate location without requiring the use of an interface and without the author having to select a cell or a range of cell where he desires the formula to be.

It is an object of this invention to provide a method for automating digital spreadsheet formulas comprising the steps of recognizing formulas with their names in real-time and without the author's intervention, of recognizing and memorizing the formula's variables, of determining if there is missing information, of producing an interface to help complete the missing information, of determining if there is any obvious error in a variable, of producing an interface to help correct the erroneous variable, of locating the most likely place for the result, of ascertaining that there is no other data at that location, of either confirming to overwrite the data or choosing another location if there is data at that location and of inserting the resulting formula at the chosen location.

### BRIEF DESCRIPTION OF THE DRAWINGS

FIG. 1 is part of a spreadsheet's graphical user interface showing various formula variables names, their variables and a formula name that is about to be completed.

FIG. 2 is part of a spreadsheet's graphical user interface showing various formula variables names, their variables and a formula name and its formula as in FIG. 1 after its formula name is completed.

FIG. 3 is a flow chart showing the method of automating spreadsheet formulas.

### DETAILED DESCRIPTION OF THE PREFERRED EMBODIMENT

Although the preferred embodiment of the present invention will be described with respect to spreadsheet programs, those skilled in the art will recognize that the present invention may be utilized in connection with other software programs in which mathematical or other types of formulas are entered.

Turning to the nomenclature of the specification, the detailed description that follows contains words whose meanings should include but are not limited to the following meanings. A function relates each of its inputs to exactly one output, it may be unary such as the Absolute value of a number or it can apply to a plurality of numbers. In mathematics a formula is a concise way of expressing information; it may include a function or a plurality of functions. An author may choose a formula's name or that name can be part of a nomenclature generally accepted by a community, such as the financial community; for example Pmt is recognized to be a payment by the financial community; it can have synonyms such as Payment, Periodic Payment and Payment Amount. A formula also has mathematical variables that provide means to calculate it and to arrive at its result. In a spreadsheet, the result is usually displayed rather than the formula itself, though the formula is shown in the formula bar.

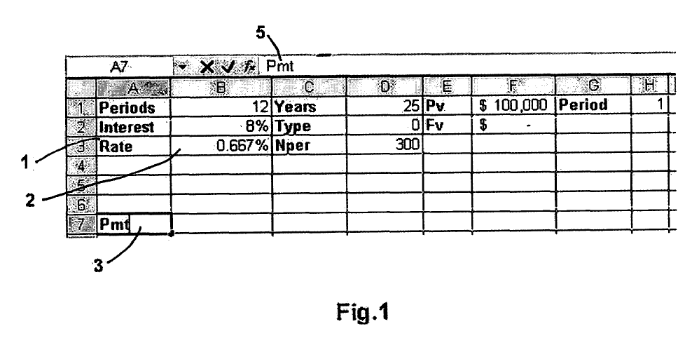

FIG. 1 illustrates part of a spreadsheet window that includes 8 columns, A through H and 7 rows. Many cells contain variables and their titles that could have been placed anywhere in that worksheet and that could be placed in other worksheets of the same workbook or of other workbooks, or in a database or in a web page or other location that is linked to the present worksheet. The formula, the variables and their titles are exemplary. The formula name Rate is contained in cell A3, here identified as 1 and its variable, 0.667% is contained in cell B3, here identified as 2; note that the precision displayed is to 3 decimal places although the number is more precise. Cell A7, here identified as 3, is being completed and the Enter key has not yet been typed. This is reflected in the formula bar 5 that repeats the text in the active cell 3.

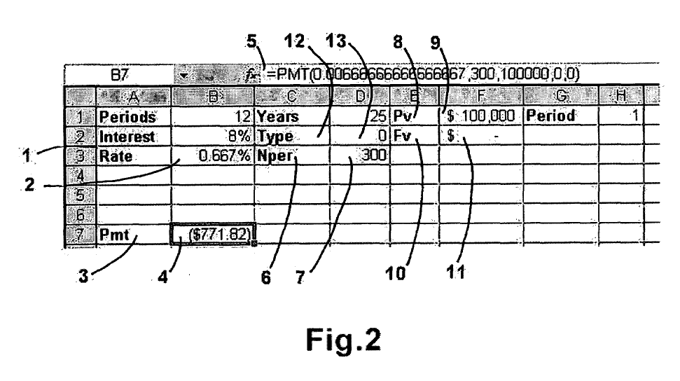

FIG. 2 illustrates part of a spreadsheet window similar to FIG. 1 where the exemplary formula name Pmt here identified as 3 has been typed and the Enter key has been pressed. The exemplary formula's name is recognized hence the exemplary formula's variable names and their variables located according to the author's practices are sought everywhere in that worksheet's used range, everywhere in the workbook's worksheets used range, in the databases and Web pages or other locations that are linked to the active worksheet. In the present case, the interest rate here identified as 2 is associated with its name Rate here identified as 1, the number of periods here identified as 7 is associated with its name Nper here identified as 6, the present value here identified as 9 is associated with its name PV here identified as 8, the future value that is nil here identified as 11 is associated with its name Fv here identified as 10 and the type of payment here identified as 13 is associated with its name Type here identified as 12. Since all the required information is complete and since there is no apparent error, Excel's formula=PMT(Rate, Nper, Pv, Fv, Type) is constructed as =PMT(0.00666666666666667,300,100000,0,0) and it replaces the text in the formula bar here identified as 5. The most likely place to put the formula result is in a cell adjacent to the formula's name here identified as 3 and to its left according to usual occidental practices, here identified as 4.

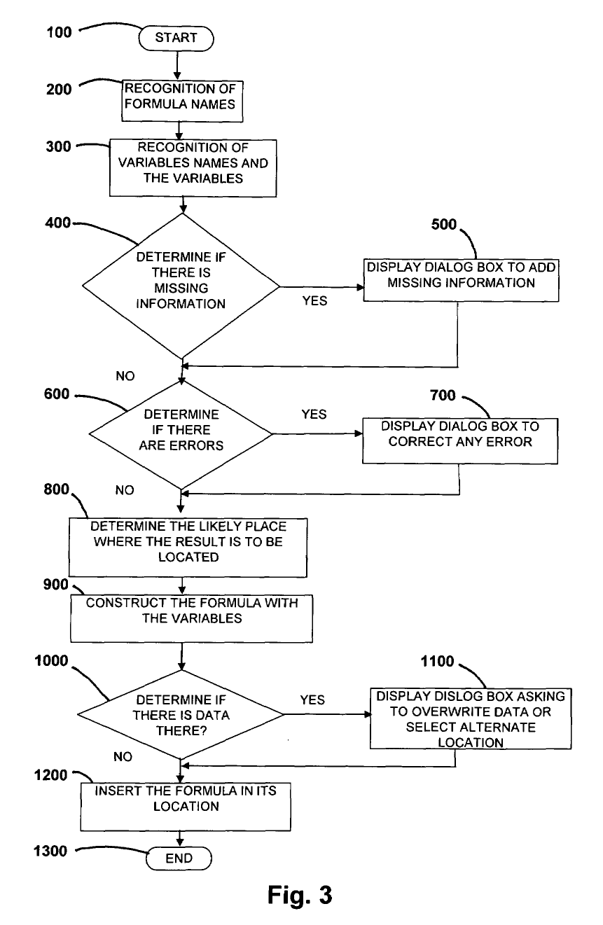

The author would have the option to select other practices if he so chooses. FIG. 3 is a flow chart of the method and its steps to construct and display a formula. The method starts at 100 as soon as the workbook is opened. Step 200 that may be included in every worksheet code or it may be embedded in the spreadsheet's code, this step checks automatically and without the author's intervention all changes and if a formula's name is recognized according to a list of formulas and their synonyms. The next step 300 consists of seeking all the variables that can be linked to the formula by traversing the active worksheet and other linked locations, of recognizing the variables' names and their values and storing them temporarily. There is a check in step 400 to find out if some variables are missing. Since variable names may become anticipated results, the author may have the option to be notified of missing information if there is more than one missing variable. If some information is missing the flow will branch to step 500 that will display an interface to inform the author of the missing variable and to help him complete the missing information by adding the appropriate value and by choosing a location where he might opt to place this information. Once this is completed or if there was no missing information, the flow goes to step 600 to determine if there is any obvious error, such as text where a numerical variable is expected. If an error is detected the flow will branch to step 700 that will display an interface to inform the author of the error and to help him correct it and it will replace the erroneous variable. Once all errors are corrected or if there is no error, the flow will continue to step 800 to determine the most likely location where the formula should be inserted. Occidental traditions expect that a result will be placed at the right in the cell adjacent to formula's name. There may be a plurality of results in a series of columns such as in Grand Totals. There may be other variations such as blank columns or borders that have to be taken into consideration. The author may also opt to place his formulas in columns or on the left of their names and this is also taken into account. The next step 900 consists of constructing the formula with the variables in memory. Step 1000 consists of checking if there already is data at the likely location where the formula would be inserted. If there already is information, the flow will branch to step 1100 that will display an interface to ask the author permission to overwrite the existing data or to select an alternate location. Once this is completed or if there was no data at that location step 1200 will insert the completed formula in its selected location, thereby making the spreadsheet display the correct result. The flow will then terminate at step 1300 when the worksheet is closed or the workbook is exited.

In addition to the functions embedded in the spreadsheet's program, other user-defined functions (UDF) can be added that will provide similar auto-calculations.

In compliance with the statute, the invention has been described in a language more or less specific as to structure and methods features. It is to be understood, however, that the invention is not limited to the specific features described, since the means herein disclosed comprise exemplary forms of putting the invention into effect. The invention is, therefore, claimed in any of its forms or modifications within the proper scope of the appended claims appropriately interpreted in accordance with the doctrine of equivalents and their applicable judicial doctrines.

The inventor claims:

1) A system for automating a digital spreadsheet formula comprising:
means to recognize formula names and their associated variables in real-time and without the author's intervention;
means to construct a formula based on the formula's name and its variables;
means to automatically inserts the completed formula at the place associated with the formula's name.

2) A system as recited in claim 1, further comprising:
means to detect errors and missing information;
means to correct detected errors and complete missing information;
means to detect if there already is data in the location;
means to propose an alternate location if there would have been an improper overwrite.

3) A method for automating a the construction of a digital spreadsheet formula comprising the steps of:
recognizing a formula's name in real time and without the author's intervention;
traversing the spreadsheet's used range and recognizing the formula variables names and their associated value in real-time and without the author's intervention;
identifying missing information;
displaying a dialog box to assist in adding the missing information to the spreadsheet;
identifying errors in the variables;
displaying a dialog box to assist in correcting the erroneous variables;
constructing the completed formula;
locating the cell where the result is expected to be placed in association with the formula's name;
displaying a dialog box to confirm or not an overwrite;
displaying a dialog box to select an alternate location if there would be a wrongful overwrite;
inserting the completed formula in the cell associated with the expected result.
